(19) United States
(12) Patent Application Publication
(10) Pub. No.: US 2009/0068319 A1
(43) Pub. Date: Mar. 12, 2009

(54) UNBAKED CHINESE DUMPLINGS, BAKED CHINESE DUMPLINGS AND PROCESS FOR PRODUCING THE SAME

(75) Inventors: Akihiro Kitagawa, Funabashi-shi (JP); Mariko Kitagawa, Funabashi-shi (JP)

Correspondence Address: DARBY & DARBY P.C., P.O. BOX 770, Church Street Station, New York, NY, 10008-0770, US

(73) Assignee: Nichirei Corporation, Tokyo (JP)

(21) Appl. No.: 12/269,602

(22) Filed: Nov. 12, 2008

Related U.S. Application Data
(63) Continuation of application No. 10/520,293, filed on Dec. 30, 2004.

(30) Foreign Application Priority Data
Jul. 5, 2002 (JP) 2002-196851

(51) Int. Cl. A21D 6/00; A21D 13/00; A23L 1/16; A23P 1/08

(52) U.S. Cl. 426/95; 426/297; 426/94; 426/331; 426/327; 426/661; 426/439

(57) ABSTRACT

The present invention provides fried Chinese dumplings, such as fried jiao-zi, shao-mai, won-ton, and steamed bread, unfried Chinese dumplings, and methods for producing the same, wherein deterioration of the crispness of their browned skin is sufficiently inhibited after the dumplings are fried, even when a certain period of time is passed after frying, or even when the dumplings are stored in a frozen state. The unfried Chinese dumpling of the present invention has a crispness deterioration inhibitor provided on the external surface of the dough sheet for inhibiting deterioration with time of crispness of the dough sheet after the dumpling is fried. The inhibitor comprising grain powders and a starch hydrolysate (A-1) in powder form having a bulk density of not lower than 3.0 ml/g.

### FIELD OF ART

The present invention relates to fried Chinese dumplings, such as fried jiao-zi, shao-mai, won-ton, and steamed bread, provided with a crispness deterioration inhibitor that is capable of inhibiting deterioration with time of crispness of the dough sheet of the Chinese dumpling, as well as to unfried Chinese dumplings for producing the fried Chinese dumplings, and a method for producing the same.

### BACKGROUND ART

Fried Chinese dumplings, typically fried jiao-zi, are popular for their combination of soft texture of the filling and crispness of the browned skin.

Recently, prepared food, take-out food, delivery food, and frozen food sold at food floors have increasingly been demanded, and the fried Chinese dumplings are also sold in such forms. Fried Chinese dumplings sold in the form of prepared food, take-out food, and delivery food, inevitably go through a certain period of time before they are served, and frozen fried Chinese dumplings inevitably experience migration of moisture from the filling to the skin during frozen storage. The crispness of the browned skin of fried Chinese dumplings is remarkably deteriorated under such conditions.

In order to eliminate such defects and to prevent sticking between unfried Chinese dumplings or between the dumplings and the container, the external surface of dumplings is conventionally floured with starch or the like. This process may inhibit the dumplings from sticking each other or to the container, but is hardly effective in inhibiting deterioration of the crispness.

In view of the above, various techniques have been proposed for inhibiting deterioration with time of the crispness of fried Chinese dumplings. For example, as a treatment of the external surface of the skin of fried jiao-zi, there has been proposed to apply an emulsion consisting of water containing grain powders and egg protein, oils and fats, and an emulsifier, on the external surface of jiao-zi before frying (JP-2850690-B2), or to apply an edible oil on the browned side of fried jiao-zi (JP-10-271978-A).

However, these methods are not yet sufficient for inhibiting deterioration of the crispness. Further, the material applied to the external surface of the skin is in the form of a liquid, which has poor workability and is bothersome to handle.

### SUMMARY OF THE INVENTION

It is therefore an object of the present invention to provide unfried and fried Chinese dumplings wherein deterioration of the crispness of their browned skin is sufficiently inhibited after the dumplings are fried, even when the dumplings are stored in a frozen state, or even when a certain period of time is passed after frying, as well as a method for producing such Chinese dumplings.

It is another object of the present invention to provide a crispness deterioration inhibitor for use in producing unfried Chinese dumplings, which is easy to handle, and capable of sufficiently inhibiting deterioration of the crispness of browned skin of fried dumplings after the dumplings are fried, even when the dumplings are stored in a frozen state, or even when a certain period of time is passed after the dumplings are fried.

According to the present invention, there is provided an unfried Chinese dumpling with a filling wrapped in a dough sheet, having a crispness deterioration inhibitor provided on the external surface of the dough sheet for inhibiting deterioration with time of crispness of the dough sheet after the dumpling is fried, said crispness deterioration inhibitor comprising grain powders and a starch hydrolysate (A-1) in powder form having a bulk density of not lower than 3.0 ml/g.

According to the present invention, there is also provided a method for producing an unfried Chinese dumpling comprising the steps of:

(a-1) wrapping a filling with a dough sheet, and

(a-2) applying the above-mentioned crispness deterioration inhibitor to adhere to a surface of the dough sheet opposite to a surface in contact with the filling.

According to the present invention, there is further provided a crispness deterioration inhibitor for use in the above method for producing an unfried Chinese dumpling, said inhibitor comprising:

grain powders and

a starch hydrolysate (A-1) in powder form having a bulk density of not lower than 3.0 ml/g.

According to the present invention, there is also provided a fired Chinese dumpling obtained by frying the above-mentioned unfried dumpling, and having a browned side on its external surface.

According to the present invention, there is also provided a method for producing a fried Chinese dumpling comprising the step of (b) frying the above-mentioned unfried dumpling in a frying pan.

### PREFERRED EMBODIMENTS OF THE INVENTION

The present invention will now be explained in detail.

The fried Chinese dumpling with a filling wrapped in a dough sheet according to the present invention includes, for example, fried jiao-zi, fried shao-mai, fried won-ton, and fried steamed bread. As used herein, “frying” is a cooking method wherein a frying pan or the like is lightly oiled, and a Chinese dumpling is fried to brown a desired side of the external surface of the dough sheet. Frying is different from cooking methods such as steaming a Chinese dumpling or deep-frying a Chinese dumpling in oil. The resulting fried Chinese dumpling has a texture completely different from that of a steamed or deep-fried Chinese dumpling. For example, the fried shao-mai is prepared by frying shao-mai in a frying pan or the like, and is different from ordinary steamed shao-mai or deep-fried shao-mai. The fried won-ton is different from ordinary boiled won-ton, and is prepared by frying won-ton in a frying pan or the like and used as an ingredient of chow mein (fried Chinese noodle) or the like.

The unfried Chinese dumpling with a filling wrapped in a dough sheet according to the present invention is a Chinese dumpling that is prepared by wrapping a filling prepared in a conventional or the like method depending on the kind of a dumpling to be produced, with a dough sheet prepared in a conventional or the like method, and is not yet fried. The unfried Chinese dumpling has, at least on the external surface of the dough sheet to be fried, a crispness deterioration inhibitor for inhibiting deterioration with time of crispness of the dough sheet after the dumpling is fried, containing grain powders and a particular starch hydrolysate (A-1) in powder form. The inhibitor is preferably applied to adhere at least to the side to be fried of the external surface of the dough sheet, and may be applied to adhere to the overall external surface of the dough sheet.

As used herein, the grain powders in the inhibitor means to include starches such as corn starch, and also modified starches such as cross-linked starch, alpha starch, wet heat-treated starch, but not to include starch hydrolysates. Examples of the grain powders may include wheat flour, rice flour, corn flour, barley flour, buckwheat flour, potato flour, soybean flour, red bean flour, barnyardgrass seed flour, foxtail millet flour, proso millet flour, wheat starch, nonglutinous rice starch, and corn starch. Among these, wheat starch, wet heat-treated starch, nonglutinous rice starch, corn starch, alpha starch, and rice flour are particularly preferred for giving natural flavors.

The content of the grain powders in the inhibitor is usually 10 to 99 wt %, preferably 50 to 90 wt % of the total weight of the inhibitor. Desired effects are hardly obtained outside this range, which is not preferred.

The starch hydrolysate (A-1) in the inhibitor is in powder form, and has a bulk density of not lower than 3.0 ml/g, preferably 3.0 to 6.0 ml/g, more preferably 3.5 to 5.0 ml/g. Wheat starch, soft flour, ordinary powder starch, and hydrolysates of these usually have a bulk density of about 1.4 ml/g or lower, and ordinary dextrin has a bulk density of about 2.2 ml/g at most. A starch hydrolysate having a bulk density of not lower than 3.0 ml/g has never been used for fried Chinese dumplings.

As used herein, the bulk density represents a value measured in accordance with JIS K 1201-1:2000 “Sodium Carbonate for Industrial Use—Part 1: Determination of Bulk Density”.

The starch hydrolysate (A-1) may be prepared, for example, by drying an aqueous solution of a starch hydrolysate having a DE (Dextrose Equivalent) of not higher than 18, preferably 3.5 to 18, in a drum dryer into powders. Details of this method are taught, for example, in JP-60-12399-B. According to this publication, the resulting starch hydrolysate is reported to have a specific volume bulk of 6 to 20 ml/g. Further, the starch hydrolysate as a raw material for preparing the starch hydrolysate (A-1) may be prepared by hydrolyzing various starches, such as sweet potato starch, potato starch, corn starch, wheat starch, or rice starch, in accordance with a conventional method to have a desired DE value.

The starch hydrolysate (A-1) may be prepared as mentioned above, or a commercial product, such as “PINEFLOW” or “PINEFLOW S” (both trade names, manufactured by MATSUTANI CHEMICAL INDUSTRY CO., LTD.), may also be used as the starch hydrolysate (A-1).

The content of the starch hydrolysate (A-1) is usually 0.1 to 40 wt %, preferably 1 to 20 wt % of the total weight of the inhibitor. Desired inhibitory effects are hardly obtained outside this range, which is not preferred.

In addition to the grain powders and the starch hydrolysate (A-1) mentioned above, the inhibitor may optionally contain at least one of, or both of dextrin (A-2) having a bulk density of 1.0 to 2.2 ml/g, preferably 1.4 to 2.0 ml/g, and polysaccharides thickener in powder form for further improving the inhibitory effect on deterioration of crispness.

Examples of the dextrin (A-2) may include dextrin and cyclodextrin.

The content of the dextrin (A-2) is usually not more than 40 wt %, preferably 0.1 to 40 wt %, more preferably 1 to 20 wt % of the total weight of the inhibitor. Desired inhibitory effects are hardly improved outside this range, which is not preferred.

Examples of the polysaccharides thickener may include gums such as xanthan gum, tamarind gum, arabic gum, guar gum, gellan gum, and psyllium seed gum, agar, gelatine, HM pectin, glucomannan, sodium alginate, iota carrageenan, curdlan, and soybean polysaccharides, all in powder form. Among these, xanthan gum, tamarind gum, arabic gum, psyllium seed gum, agar, HM pectin, glucomannan, sodium alginate, and iota carrageenan are particularly preferred. These may be used alone or in mixture of two or more kinds.

The content of the polysaccharides thickener is usually not more than 20 wt %, preferably 0.1 to 20 wt %, more preferably 1 to 10 wt % of the total weight of the inhibitor. Desired inhibitory effects are hardly improved outside this range, which is not preferred.

The inhibitor may be obtained by homogeneously mixing the components mentioned above, and may optionally contain other powder components, such as seasoning powders, as long as the desired inhibitory effect is not impaired.

The inhibitor may be used in the manner to be discussed later, or may also be used at home or the like by applying the inhibitor to adhere to the desired external surface of unfried Chinese dumplings upon frying or before refrigerating or freezing.

The unfried Chinese dumpling of the present invention may optionally has an oil and fat layer on the surface of the wrapper dough sheet to be in contact with the filling, for further improving the desired inhibitory effect.

Examples of the oils and fats forming the oil and fat layer may include vegetable oils, such as soybean oil, rapeseed oil, olive oil, and palm oil, and hydrogenated oils thereof; and animal oils and fats such as lard and beef tallow. These may be used alone or in mixture. The oil and fat layer may preferably contain food powders for further improving the desired inhibitory effect.

Examples of such food powders may include wheat flour, rice flour, corn flour, barley flour, buckwheat flour, potato flour, soybean flour, red bean flour, barnyardgrass seed flour, foxtail millet flour, proso millet flour, wheat starch, nonglutinous rice starch, and corn starch. The content of the food powders, if any, is usually 5 to 50 wt %, preferably 10 to 30 wt % of the total weight of the oil and fat layer.

The oil and fat layer is preferably formed on the surface of the wrapper dough sheet to be in contact with the filling at least at a part to be in contact with the filling, or may be formed on the overall surface to be contacted with the filling. For example, in industrial scale production, the oil and fat layer may be formed by dropping a mixture of the oils and fats and the food powders composing the oil and fat layer, onto the dough sheet.

The unfried Chinese dumpling of the present invention includes, for example, a steamed Chinese dumpling, a Chinese dumpling with a raw dough sheet, a frozen Chinese dumpling, and a refrigerated Chinese dumpling, as long as the dumpling is not yet fried, and has the crispness deterioration inhibitor and optionally the oil and fat layer formed at a particular part of the dough sheet.

The unfried Chinese dumpling of the present invention may be produced, for example, by the following method of the present invention.

The method for producing an unfried Chinese dumpling according to the present invention includes the steps of (a-1) wrapping a filling with a dough sheet, and (a-2) applying the above-mentioned inhibitor to adhere to a surface of the dough sheet opposite to the surface in contact with the filling.

Step (a-1) may be carried out by preparing a filling in a conventional or the like method depending on the kind of a dumpling to be produced, and a dough sheet in a conventional or the like method, and wrapping the filling with the dough sheet in a desired shape depending on the dumpling to be produced.

Step (a-1) may preferably include step (p) of providing the oil and fat layer on the surface of the dough sheet to be in contact with the filling, so as to obtain a fried Chinese dumpling with further improved desired inhibitory effect.

Step (p) may be carried out by applying the oils and fats composing the oil and fat layer at a particular part of the dough sheet, or on the overall surface to be contacted with the filling, before placing the filling on the dough sheet.

In step (a-2), the inhibitor is the above-mentioned inhibitor, that is, the inhibitor containing the grain powders and a starch hydrolysate (A-1) in powder form having a particular bulk density, and optionally dextrin (A-2) in powder form, polysaccharides thickener in powder form, seasoning powders, and the like.

The inhibitor may be applied to adhere to a surface of the dough sheet opposite to the surface in contact with the filling by applying the inhibitor to adhere to the entire surface, or at least to the side to be fried of the surface of the dough sheet opposite to the surface in contact with the filling, before or after step (a-1). Taking the efficiency and the amount of the inhibitor to fall off into account, the application may be carried out after step (a-1) or after step (a-3) to be discussed later.

The inhibitor may be applied, for example, in the same way as flouring, or by spreading the inhibitor over the bottom of a storage container such as a tray, and placing the Chinese dumpling on the inhibitor to have the inhibitor adhere to the dumpling.

The amount of the inhibitor to be applied to adhere may suitably be selected, taking an amount required for achieving the desired effect of the present invention into account, depending on the kind of the dumpling to be produced. For example, in the case of fried jiao-zi, the inhibitor in the amount of 0.4 to 20 wt %, preferably 0.8 to 10 wt % of the weight of a unfried jiao-zi, may be applied to adhere to a particular part of the dough sheet.

According to the method of the present invention, the unfried Chinese dumpling of the present invention may be produced by carrying out steps (a-1) and (a-2). The method may optionally include at least one of the steps of (a-3) steaming the unfried Chinese dumpling with a filling wrapped in a dough sheet, and (a-4) freezing the unfried Chinese dumpling, and also other steps without impairing the desired effect of the present invention, or with expectation of other effects. Such other steps may include, for example, spraying a suitable amount of water after step (a-1).

The steaming step (a-3) is preferably carried out after step (a-1), or after step (a-2).

Step (a-4) is a step for making the unfried Chinese dumpling into a frozen product, and may be carried out according to a conventional freezing process. This step may usually be the last step in the present method for producing an unfried Chinese dumpling.

The fried Chinese dumpling according to the present invention is obtained by frying the above-mentioned unfried Chinese dumpling, has a browned side on its external surface, and may be produced, for example, by the method for producing a fried Chinese dumpling according to the present invention to be discussed later. In the fried Chinese dumpling, the inhibitor adhered to the desired external surface of the unfried dumpling, usually absorbs moisture during cooking, is converted into alpha starch, dehydrated by frying, and formed into a crispy film.

The fried Chinese dumpling of the present invention may be in the form of a frozen or refrigerated product, which may be made according to a conventional freezing or refrigerating method.

In the present method for producing a fried Chinese dumpling, step (b) of frying the above-mentioned unfried Chinese dumpling in a frying pan, is carried out, according to a conventional method depending on the kind of the dumpling. This frying may be carried out by lightly oiling a frying pan and frying the Chinese dumpling as it is, or steam-frying with hot water or the like added into the pan upon frying.

Since the unfried Chinese dumpling, the fried Chinese dumpling, and the method for producing the same according to the present invention employ the inhibitor, a fried Chinese dumpling with the crispness of the browned side being maintained, may be obtained. Accordingly, the present Chinese dumpling is particularly useful as a fried Chinese dumpling in the form of prepared food, delivery food, or take-out food, and as unfried or fried Chinese dumpling for freezing or refrigerating.

### EXAMPLES

The present invention will now be explained in more detail with reference to Examples, which are illustrative only, and do not intend to limit the present invention.

### Examples 1-1 to 1-21 and Comparative Examples 1-1 to 1-3

Each composition of powders shown in Table 1 were homogeneously mixed to prepare a crispness deterioration inhibitor.

Here, in Table 1, “PINEFLOW” and “PINEFLOW S” are trade names and products of MATSUTANI CHEMICAL INDUSTRY CO., LTD. The bulk density of these products was measured in accordance with JIS K 1201-1:2000 “Sodium Carbonate for Industrial Use—Part 1: Determination of Bulk Density”. The results were that the bulk density of PINEFLOW (a) was 4.00 ml/g, that of PINEFLOW (b) was 3.85 ml/g, and that of PINEFLOW S was 4.55 ml/g. The dextrin used was “SANDEC #30” (trade name) manufactured by SANWA CORNSTARCH CO., LTD., having a bulk density of 1.85 ml/g. The wheat starch used had a bulk density of 1.27 ml/g. PINEFLOW (a) and (b) are commercial products under the same trade name but of different lots.

TABLE 1

| | | Starch | Dextrin | Polysaccharides |
|---|---|---|---|---|
| | Grain powders | hydrolysate | (A-2) | thickener |
| | (wt %) | (A-1) (wt %) | (wt %) | (wt %) |
| Ex. 1-1 | Wheat starch (95) | PINEFLOW | — | — |
| | | (a) (5) | | |
| Ex. 1-2 | Wheat starch (93) | PINEFLOW | — | Agar powder (2) |
| | | (a) (5) | | |
| Ex. 1-3 | Wheat starch (88) | PINEFLOW | Dextrin (5) | Agar powder (2) |
| | | (a) (5) | | |
| Ex. 1-4 | Rice flour (88) | PINEFLOW | Dextrin (5) | Agar powder (2) |
| | | (a) (5) | | |
| Ex. 1-5 | Potato starch (88) | PINEFLOW | Dextrin (5) | Agar powder (2) |
| | | (a) (5) | | |
| Ex. 1-6 | Wet heat-treated | PINEFLOW | Dextrin (5) | Agar powder (2) |
| | starch (88) | (b) (5) | | |
| Ex. 1-7 | Nonglutinous | PINEFLOW | Dextrin (5) | Agar powder (2) |
| | rice starch (88) | (b) (5) | | |
| Ex. 1-8 | Corn starch (88) | PINEFLOW | Dextrin (5) | Agar powder (2) |
| | | (b) (5) | | |
| Ex. 1-9 | α-starch (88) | PINEFLOW | Dextrin (5) | Agar powder (2) |
| | | (b) (5) | | |
| Ex. 1-10 | Wheat starch (88) | PINEFLOW | Dextrin (5) | Xanthan gum (2) |
| | | (a) (5) | | |
| Ex. 1-11 | Wheat starch (88) | PINEFLOW | Dextrin (5) | HM pectin (2) |
| | | (a) (5) | | |
| Ex. 1-12 | Wheat starch (88) | PINEFLOW | Dextrin (5) | Tamarind gum (2) |
| | | (a) (5) | | |
| Ex. 1-13 | Wheat starch (88) | PINEFLOW | Dextrin (5) | Arabic gum (2) |
| | | (b) (5) | | |
| Ex. 1-14 | Wheat starch (88) | PINEFLOW | Dextrin (5) | Glucomannan (2) |
| | | (b) (5) | | |
| Ex. 1-15 | Wheat starch (88) | PINEFLOW | Dextrin (5) | Sodium alginate (2) |
| | | (b) (5) | | |
| Ex. 1-16 | Wheat starch (88) | PINEFLOW | Dextrin (5) | Iota carrageenan (2) |
| | | (b) (5) | | |
| Ex. 1-17 | Wheat starch (88) | PINEFLOW | Dextrin (5) | Psyllium seed gum (2) |
| | | (b) (5) | | |
| Ex. 1-18 | Wheat starch (88) | PINEFLOW | Dextrin (5) | Soybean saccharides (2) |
| | | (b) (5) | | |
| Ex. 1-19 | Wheat starch (95) | PINEFLOW S | — | — |
| | | (5) | | |
| Ex. 1-20 | Wheat starch (93) | PINEFLOW S | — | Agar powder (2) |
| | | (5) | | |
| Ex. 1-21 | Wheat starch (95) | PINEFLOW | — | — |
| | | (b) (5) | | |
| Comp. Ex. 1-1 | Wheat starch (95) | — | Dextrin (5) | — |
| Comp. Ex. 1-2 | Wheat starch (93) | — | Dextrin (5) | Agar powder (2) |
| Comp. Ex. 1-3 | Wheat starch (100) | — | — | — |

### Examples 2-1 to 2-20 and Comparative Examples 2-1 to 2-4

As a jiao-zi dough sheet, commercially available jiao-zi skins (manufactured by TOKYO FOODS, trade name “GYOZA NO KAWA NAMA” (raw jiao-zi skin), 7 g/sheet) were used, a filling for jiao-zi was prepared in accordance with a conventional method, 18 g of the filling per one piece of jiao-zi were wrapped with the skin, and a number of jiao-zi were produced.

Each inhibitor prepared in Examples 1-1 to 1-20 and Comparative Examples 1-1 to 1-3 shown in Table 2 was spread over the bottom of a separate tray, and ten pieces of jiao-zi prepared above were placed in each tray with the side to be fried down. The amount of each inhibitor supplied to the tray was such that about 0.75 g of the inhibitor was applied to adhere to one piece of jiao-zi by the above operation. Next, 0.6 g of water per piece of jiao-zi was sprayed over each tray, and the jiao-zi were steamed in a convection oven at 95° C. for 7 minutes.

The steamed products were frozen at −35° C. to prepare frozen products. The frozen products were placed on a lightly-oiled frying pan, lightly fried, and then steam-fried with water added into the pan, to prepare fried jiao-zi. In Example 2-21, the jiao-zi was not steamed but frozen in a raw state, and then fried in the same manner.

Twenty-five expert panels ate the resulting fried jiao-zi immediately after frying, and after one, two, three, and four hours of storage at room temperature, respectively, and evaluated crispness of the browned side of the dough sheet. The evaluation was made by scoring the jiao-zi on a ±3 point scale, given that the texture of the jiao-zi without the inhibitor prepared in Comparative Example 2-1 taken immediately after frying was the standard point 0. The results are shown in Table 2 as the average of all the panels, wherein better crispness corresponds to higher positive numbers, and greater deterioration of crispness corresponds to larger negative numbers.

TABLE 2

| | Kind of | Immediately | after | after | after | after |
|---|---|---|---|---|---|---|
| | inhibitor | after frying | 1 hr. | 2 hrs. | 3 hrs. | 4 hrs. |
| Comp. Ex. 2-1 | None | 0 | −0.7 | −1.0 | −2.0 | −2.0 |
| Ex. 2-1 | Ex. 1-1 | +2.5 | +1.2 | +0.5 | −0.3 | −1.0 |
| Ex. 2-2 | Ex. 1-2 | +1.3 | +1.0 | 0 | −0.3 | −1.0 |
| Ex. 2-3 | Ex. 1-3 | +2.5 | +1.3 | +0.3 | +0.5 | +0.1 |
| Ex. 2-4 | Ex. 1-4 | +2.3 | +1.3 | +0.3 | +0.5 | +0.1 |
| Ex. 2-5 | Ex. 1-5 | +2.5 | +1.3 | +0.3 | +0.3 | +0.1 |
| Ex. 2-6 | Ex. 1-6 | +2.4 | +2.1 | +1.5 | +0.9 | 0 |
| Ex. 2-7 | Ex. 1-7 | +2.1 | +1.4 | +0.9 | +0.6 | +0.5 |
| Ex. 2-8 | Ex. 1-8 | +2.4 | +1.5 | +1.0 | +0.8 | 0 |
| Ex. 2-9 | Ex. 1-9 | +2.5 | +2.3 | +2.0 | +1.3 | +0.5 |
| Ex. 2-10 | Ex. 1-10 | +2.3 | +1.6 | +0.9 | +0.5 | −0.2 |
| Ex. 2-11 | Ex. 1-11 | +2.3 | +1.6 | +1.4 | +0.5 | +0.4 |
| Ex. 2-12 | Ex. 1-12 | +2.4 | +1.8 | +1.1 | +0.5 | 0 |
| Ex. 2-13 | Ex. 1-13 | +2.6 | +1.9 | +1.5 | +0.9 | +0.1 |
| Ex. 2-14 | Ex. 1-14 | +2.3 | +1.9 | +1.4 | +0.5 | +0.3 |
| Ex. 2-15 | Ex. 1-15 | +2.4 | +1.8 | +1.0 | +0.3 | +0.3 |
| Ex. 2-16 | Ex. 1-16 | +2.8 | +1.9 | +1.4 | +0.5 | +0.3 |
| Ex. 2-17 | Ex. 1-17 | +2.6 | +1.9 | +1.0 | +0.4 | +0.2 |
| Ex. 2-18 | Ex. 1-18 | +2.9 | +2.0 | +1.0 | +0.2 | +0.1 |
| Ex. 2-19 | Ex. 1-19 | +2.4 | +1.4 | +0.3 | +0.1 | 0 |
| Ex. 2-20 | Ex. 1-20 | +2.4 | +1.6 | +0.3 | +0.2 | 0 |
| Ex. 2-21 | Ex. 1-3 | +2.8 | +1.8 | +1.0 | +0.4 | 0 |
| Comp. Ex. 2-2 | Comp. Ex. | +2.5 | −0.3 | −0.5 | −0.7 | −1.0 |
| | 1-1 | | | | | |
| Comp. Ex. 2-3 | Comp. Ex. | +1.5 | 0 | −0.3 | −0.6 | −0.8 |
| | 1-2 | | | | | |
| Comp. Ex. 2-4 | Comp. Ex. | +2.0 | 0 | −0.6 | −1.0 | −1.6 |
| | 1-3 | | | | | |

### Examples 3-1 to 3-2 and Comparative Example 3-1

A number of jiao-zi were prepared in the same way as in Examples 2-1 to 2-21. On the other hand, commercially available jiao-zi skins (manufactured by TOKYO FOODS, trade name “GYOZA NO KAWA NAMA” (raw jiao-zi skin), 7 g/sheet) were used, and on the surface of the skin to be in contact with the filling, 2 g of a mixed material consisting of oils and fats and food powders composed of 50 wt % soybean oil, 35 wt % lard, and 15 wt % rice powder, were dropped to form an oil and fat layer over the entire surface to be in contact with the filling. Then 18 g of a filling for jiao-zi, which was prepared in accordance with a conventional method, per piece of jiao-zi were wrapped with the skin, and a number of jiao-zi having the oil and fat layer were produced.

Next, using the inhibitor prepared in Example 1-21, jiao-zi with the oil and fat layer in Example 3-1, and jiao-zi without the oil and fat layer in Example 3-2, were steamed, frozen, and fried in the same way as in Examples 2-1 to 2-20 to prepare fried jiao-zi, and the crispness thereof was evaluated. The results are shown in Table 3, wherein Comparative Example 3-1 is the control without the inhibitor adhered.

TABLE 3

| | Kind of | Immediately | After | After | After | After |
|---|---|---|---|---|---|---|
| | inhibitor | after frying | 1 hr. | 2 hrs. | 3 hrs. | 4 hrs. |
| Comp. Ex. 3-1 | None | 0 | −1.2 | −1.8 | −2.3 | −2.7 |
| Ex. 3-1 | Ex. 1-21 | +2.8 | +1.9 | +1.5 | +0.7 | +0.5 |
| Ex. 3-2 | Ex. 1-21 | +2.3 | +1.2 | 0.6 | 0.1 | −0.7 |

What is claimed is:

1. An unfried Chinese dumpling with a filling wrapped in a dough sheet, having a crispness deterioration inhibitor provided on the external surface of said dough sheet for inhibiting deterioration with time of crispness of the dough sheet after the dumpling is fried, said crispness deterioration inhibitor comprising:
grain powders and
a starch hydrolysate (A-1) in powder form having a bulk density of not lower than 3.0 ml/g.

2. The unfried Chinese dumpling of claim 1, wherein said inhibitor further comprises at least one of dextrin (A-2) in powder form having a bulk density of 1.0 to 2.2 ml/g, and polysaccharides thickener in powder form.

3. The unfried Chinese dumpling of claim 1, wherein the content of said grain powders is 10 to 99 wt %, and the content of said starch hydrolysate (A-1) is 0.1 to 40 wt % of the inhibitor.

4. The unfried Chinese dumpling of claim 2, wherein the content of said dextrin (A-2) is 0.1 to 40 wt %, and the content of said polysaccharides thickener is 0.1 to 20 wt % of the inhibitor.

5. The unfried Chinese dumpling of claim 1, further comprising an oil and fat layer on a surface of the wrapper dough sheet in contact with the filling.

6. The unfried Chinese dumpling of claim 1 in the form of a frozen product.

7. A method for producing an unfried Chinese dumpling, comprising:
(a-1) wrapping a filling with a dough sheet, and
(a-2) applying a crispness deterioration inhibitor for inhibiting deterioration with time of crispness of the dough sheet after the dumpling is fried, to adhere to a surface of the dough sheet opposite to a surface in contact with the filling,
wherein said crispness deterioration inhibitor comprises grain powders and a starch hydrolysate (A-1) in powder form having a bulk density of not lower than 3.0 ml/g.

8. The method of claim 7, further comprising the step of (p) providing an oil and fat layer on a surface of the dough sheet to be in contact with the filling.

9. The method of claim 7, further comprising the step of (a-3) steaming the unfried dumpling with the filling wrapped in the dough sheet.

10. The method of claim 7, further comprising the step of (a-4) freezing the unfired dumpling.

11. A crispness deterioration inhibitor for use in the method of claim 7, comprising:
grain powders and
a starch hydrolysate (A-1) in powder form having a bulk density of 3.0 ml/g.

12. A fried Chinese dumpling obtained by frying the unfried Chinese dumpling of claim 1, and having a browned side on its external surface.

13. A method for producing a fried Chinese dumpling comprising the step of (b) frying the unfried Chinese dumpling of claim 1 in a frying pan.
